(19) United States
(12) Patent Application Publication
(10) Pub. No.: US 2024/0114347 A1
(43) Pub. Date: Apr. 4, 2024

(54) DYNAMIC RADIO ACCESS NETWORK SHARING

(71) Applicant: International Business Machines Corporation, Armonk, NY (US)

(72) Inventor: Sagar Tayal, Ambala City (IN)

(21) Appl. No.: 17/959,707

(22) Filed: Oct. 4, 2022

(51) Int. Cl. H04W 16/14; H04M 15/00; H04W 4/24; H04W 28/02; H04W 28/20

(52) U.S. Cl. CPC H04W 16/14; H04M 15/8027; H04W 4/24; H04W 28/0268; H04W 28/0289; H04W 28/20

(57) ABSTRACT

Disclosed embodiments provide techniques for dynamic radio access network sharing. In embodiments, local telecommunication infrastructure providers (LTIPs) and/or telecommunications operators (telcos) perform planning and infrastructure deployment, and then lease available infrastructure to telecommunications operators on a micro-location level with a radio access network exchange that allows bidding on these resources by multiple telecommunications operators. This enables opportunities to improve efficiency in terms of network resource utilization.

### FIELD

The present invention relates generally to wireless communication, and more particularly, to dynamic radio access network sharing.

### BACKGROUND

As new wireless devices and services proliferate, the demand for better quality of experience and high-efficiency wireless communication continues to increase. A radio access network (RAN) is often a major component of a wireless telecommunications system that connects individual devices to other parts of a network through a radio link. The RAN can link user equipment, such as a cellphone, computer or any remotely controlled machine, over the air interface via fiber, cable, or wireless backhaul connection. That link can go to the switching center, which can provide access to a core network, which can manage subscriber information, location and more. Over the years, the capabilities of RAN have expanded to include voice calls, text messaging, and video and audio streaming. The types of user equipment using these networks have drastically increased, including all types of vehicles, drones, and internet of things (IoT) devices.

Modern RAN architecture often utilizes a user plane and control plane for management of payload data, provisioning data, and management data. The RAN architecture usually divides the user plane and the control plane into separate elements. The RAN controller can exchange one set of user data messages through a software-defined networking switch and a second set through a control-based interface. This separation can enable the RAN to be more flexible, accommodating the network functions virtualization techniques, such as network slicing, that are beneficial for today's high-speed telecommunications equipment.

Wireless networks can allow mobile users to access real-time information from almost anywhere. The development of wireless technology for smartphones and other mobile electronic devices has revamped electronic communication capabilities, enabling features such as text messages, voice calls, video chat, and applications that allow individuals to connect with others around the world instantly. While new mobile devices and features are frequently introduced, in most cases the RAN continues to play an important role in the implementation of wireless networks.

### SUMMARY

In one embodiment, there is provided a computer-implemented method for dynamic sharing of a radio access network, comprising: determining a radio access network excess capacity factor; in response to the radio access network excess capacity factor exceeding a predetermined threshold, issuing a radio access network bandwidth offer; receiving a radio access network bandwidth offer response from a user, wherein the bandwidth offer response includes a localized geographical region; evaluating the radio access network bandwidth offer response; and provide a portion of the radio access network to the user based on the evaluating of the radio access network bandwidth offer response.

In another embodiment, there is provided an electronic computation device comprising: a processor; a memory coupled to the processor, the memory containing instructions, that when executed by the processor, cause the electronic computation device to: determine a radio access network excess capacity factor; in response to the radio access network excess capacity factor exceeding a predetermined threshold, issue a radio access network bandwidth offer; receive a radio access network bandwidth offer response from a user, wherein the bandwidth offer response includes a localized geographical region; evaluate the radio access network bandwidth offer response; and provide a portion of the radio access network to the user based on the evaluating of the radio access network bandwidth offer response.

In another embodiment, there is provided a computer program product for an electronic computation device comprising a computer readable storage medium having program instructions embodied therewith, the program instructions executable by a processor to cause the electronic computation device to: determine a radio access network excess capacity factor; in response to the radio access network excess capacity factor exceeding a predetermined threshold, issue a radio access network bandwidth offer; receive a radio access network bandwidth offer response from a user; evaluate the radio access network bandwidth offer response; and provide a portion of the radio access network to the user based on the evaluating of the radio access network bandwidth offer response.

### BRIEF DESCRIPTION OF THE DRAWINGS

FIG. 1 shows an exemplary computing environment in accordance with disclosed embodiments.

FIG. 2 shows an exemplary radio access network.

FIG. 3 is a flowchart indicating process steps for disclosed embodiments.

FIG. 4 shows an exemplary ecosystem in accordance with disclosed embodiments.

FIG. 5 is a sequence diagram for disclosed embodiments.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Currently, it can be very challenging for a telecommunications operator (Telco) to borrow or lease radio resources, and the allocation of resources may not be performed in an optimal manner. This reality is forcing telco operators to own infrastructure and radio resources, even if the return-on-investment (ROI) is not viable. While radio access network (RAN) sharing can occur across a large geography, this is not desirable as major telco operators already have a large infrastructure in place. Furthermore, deploying new infrastructure just for special events and/or circumstances would result in a poor overall ROI for the network build out.

Disclosed embodiments provide techniques for dynamic radio access network sharing. In embodiments, local telecommunication infrastructure providers (LTIPs) and/or telcos perform planning and infrastructure deployment, and then lease available infrastructure to telco operators on a micro-location level with a RAN exchange that allows bidding on these resources by multiple telcos. This enables opportunities to improve efficiency in terms of network resource usage, as well as provide opportunities to monetize underutilized resources.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

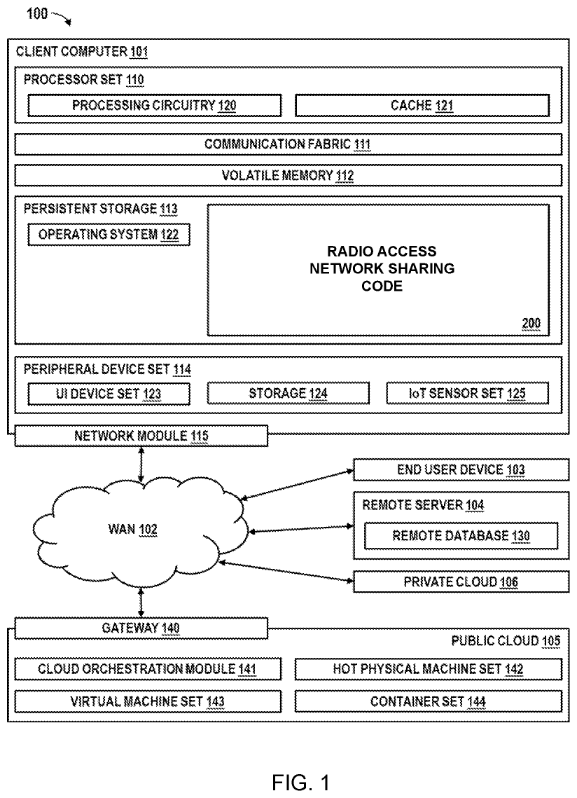

FIG. 1 shows an exemplary computing environment 100 in accordance with disclosed embodiments. Computing environment 100 contains an example of an environment for the execution of at least some of the computer code involved in performing the inventive methods, such as dynamic radio access network sharing code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

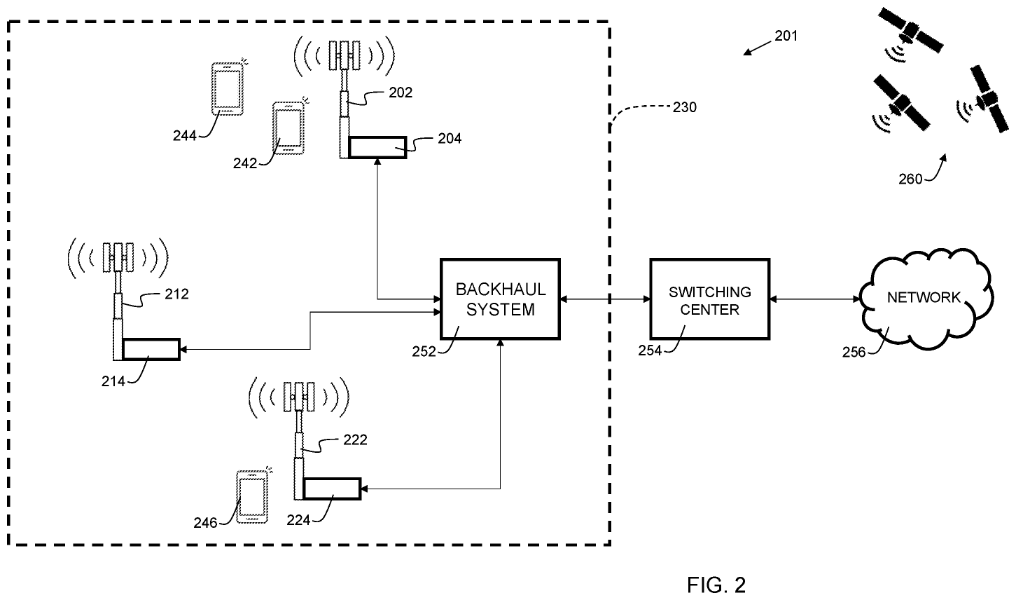

FIG. 2 shows an example 201 of a radio access network. Radio access network 230 can include multiple towers, indicated as 202, 212, and 222. While three towers are shown in FIG. 2, in practice, there can be more or fewer towers within radio access network 230. Each tower may have a corresponding base station, indicated as 204, 214, and 224, respectively. The base station can provide functionality such as processing radio signals, detecting errors, performing security functions, and/or load balancing. The base stations may convert the radio signals into electrical signals for communication over a computer network, utilizing protocols such as ethernet, TCP/IP, UDP, and the like.

The base stations 204, 214, and 224 communicate with a backhaul system 252. The backhaul system 252 can include one or more servers, virtual machines, and/or containerized applications. The backhaul system 252 may implement one or more virtual network functions (VNFs), or portions thereof. The virtual network functions can include, but are not limited to, routing functions, firewall functions, orchestration, video analytics, security functions, and others. The backhaul system 252 may communicate with a switching center 254. The switching center 254 can include hardware and software functions for communicating with network 256. Network 256 can include the internet, and/or other wide area networks. The switching center 254 may also facilitate communication to other proprietary networks, such as landline (POTS) networks, and/or other proprietary communication networks.

Various mobile electronic devices, indicated as 242, 244, and 246 may be present within the area served by the RAN 230. The mobile electronic devices can be associated with end users. The mobile electronic devices can be smartphones, wearable computers, and/or other types of mobile electronic computing devices. The mobile devices can be associated with (subscribed to) a telco operator. As an example, devices 242 and 244 can be associated with a first telco operator, while mobile device 246 can be associated with a second telco operator. In some embodiments, the RAN 230 may belong to the first telco operator. The second telco operator can lease access to the RAN 230 from the first telco operator via a RAN resource exchange, in accordance with disclosed embodiments. In some embodiments, the RAN 230 may belong to an LTIP, and both the first telco operator, and second telco operator can lease RAN resources from the LTIP.

The optimal amount of RAN resources can depend on various factors, including, but not limited to, the number of mobile devices (subscribers) in a given area, the amount of activity occurring, the types of activity (e.g., text messaging, voice calls, video calls, gaming, browsing, etc.), and/or a quality-of-service (QoS). The QoS can define attributes such as overall bandwidth, peak bandwidth, traffic priority, and/or other attributes. These factors can change dramatically based on external and/or environmental conditions. As an example, a localized geographical region, such as an area of one square kilometer, may have an average RAN utilization based on an average number of subscribers in the area at a given time. However, the actual number of subscribers in the area (and hence, requesting resources from the RAN) can vary greatly over time, based on external and/or environmental events.

As an example, if a localized geographical region of one square kilometer contains a sports stadium, then when a sports event is in progress, there can be fifty thousand more subscribers in the area than when there is no event taking place. In this scenario, for telco operators that do not have adequate coverage or capacity in that localized geographical region, they may wish to lease RAN resources from the telco operator or LTIP that owns the resources of that RAN. Similarly, the owners of the RAN want to optimize revenue, and lease unused capacity where appropriate.

In addition to scheduled events, such as sporting events, unscheduled events can also cause fluctuations in demand for RAN resources. In another example, when a vehicle accident causes a major highway to close temporarily and without notice, operators of vehicles may seek alternate routes, causing an unexpected increase in demand for RAN resources when motorists deviate from normal routes due to the accident. Disclosed embodiments can accommodate this unexpected increase in demand for RAN resources by automatically generating bid requests (bandwidth offers) and receiving bid responses (bandwidth offer responses) based on anticipated resource requirements. Bid responses are evaluated based on dynamic conditions. In embodiments, the evaluation is based on crowdsourced location service data. Electronic devices such as 242, 244, and 246 can include a geolocation receiver that receives signals from satellite constellation 260. Satellite constellation 260 can include Global Positioning System satellites, GLONASS satellites, and/or other suitable geolocation satellites. Signals received from the satellite constellation enable devices such as 242, 244, and 246 to track and report location and direction of movement. In embodiments, when a large number of mobile devices report that they are heading towards a given localized geographical region, bid responses and/or bid requests can be automatically generated. The bid responses and/or bid requests can be evaluated based on the expected arrival of mobile devices in the given localized geographical region based on crowdsourced data, including crowdsourced location service data. Other crowdsourced data can include data from social media systems, such as scraping social media posts to determine an expected arrival of mobile devices in the given localized geographical region. In this way, disclosed embodiments can accommodate fluctuation in RAN resource demand for both scheduled events and unscheduled circumstances. Embodiments can include receiving a radio access network bid response from a user. The user can be a telco operator, and/or other system, entity, and/or stakeholder that is seeking additional radio access network resources.

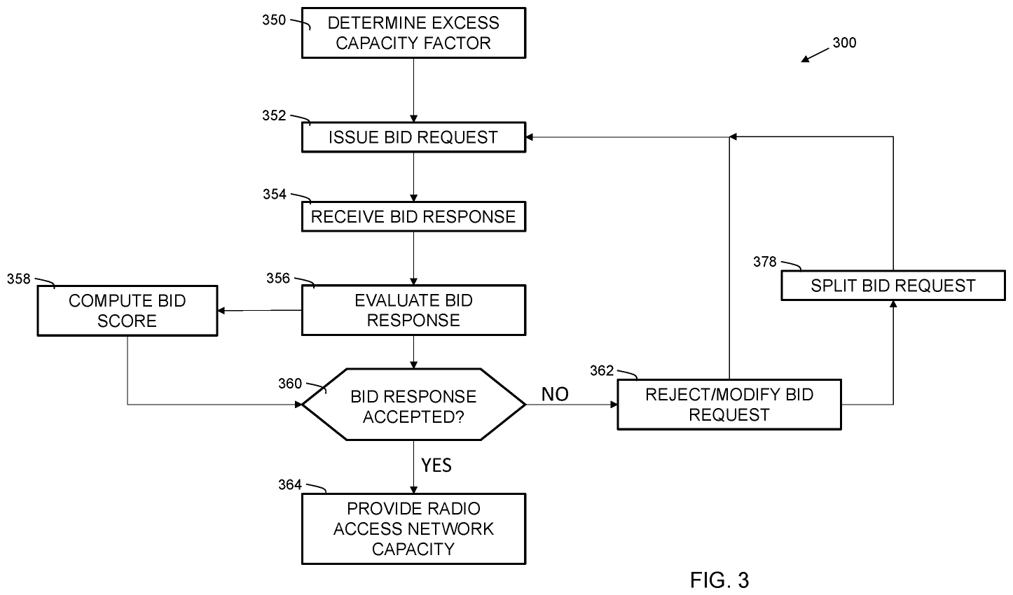

FIG. 3 is a flowchart 300 indicating process steps for disclosed embodiments. At 350, an excess capacity factor is determined. In embodiments, the capacity factor F can be determined using the following formula:

F=1−C/T, where:

C is the currently used bandwidth, and T is the total possible bandwidth. As a first example, if the total possible bandwidth T is 12 MHz (Megahertz), and the currently used bandwidth C is 4 MHz, then the capacity factor F₁ is computed as:

F₁=1−4/12=0.667

In a second example, if the total possible bandwidth T is 12 MHz (Megahertz), and the currently used bandwidth C is 11 MHz, then the capacity factor F₂ is computed as:

F₂=1−11/12=0.083

Thus, as F₁>F₂, it indicates that more capacity is available in the first example.

In some embodiments, instead of a current bandwidth, an average estimated bandwidth E can be used to compute the capacity factor as follows:

F=1−E(x)/T, where:

E(x) is the average estimated bandwidth that will be used at some future time x, and T is the total possible bandwidth. The average estimated bandwidth E is used to derive a capacity projection that can be based on external events. In embodiments, data such as sports schedules, traffic data, weather data, and social media data can be obtained by the radio access network sharing system of disclosed embodiments. This data can be used with machine learning systems, and/or heuristic algorithms, to determine an average estimated bandwidth that would be used at some future time, thereby determining a capacity projection.

As an example, if a sporting event is scheduled for two hours in the future, disclosed embodiments can factor in an influx of mobile subscribers to a given localized geographical region in advance of the scheduled event.

As another example, if traffic data indicates increased traffic, in terms of mobile network subscribers, e.g., due to road closures, disclosed embodiments can factor in an influx of mobile subscribers to a given localized geographical region based on crowdsourced location services.

As another example, if weather data indicates upcoming inclement weather, disclosed embodiments may factor in a reduced number of mobile subscribers to a given localized geographical region due to less people travelling or going out in poor weather. In this example, the average estimated bandwidth E may be lower than the currently used bandwidth C, as it may be determined that at some future time, there will be less bandwidth being consumed, and as such, capacity factor F, indicative of available capacity to lease to other telcos, may increase. In embodiments, the evaluation includes computing a capacity projection.

At 352, a bid request is issued. In embodiments, a bid request is issued when the capacity factor F exceeds a predetermined value (e.g., 0.65). In this way, the bid request is only issued when there is deemed to be at least a certain amount of available RAN resources for lease. Issuing the bid request can include sending a message to a RAN resource exchange server via a computer network. The message can include metadata pertaining to the bid request. The metadata can include a bid request number. The bid request number is a unique number associated with a given bid request. The metadata can include spectrum allocation information. The spectrum allocation information can include one or more radio frequencies included in the bid request. The metadata may further include a quality-of-service (QoS) dataset. The QoS dataset can include one or more parameters describing an expected QoS for the RAN resource allocation pertaining to the bid request. The QoS parameters can include, but are not limited to, download speed, upload speed, latency, jitter, and/or retransmission rates. The bid request, upon being received by the RAN resource exchange, can be available to telco operators that are interested in temporarily expanding capacity. The availability can be via searching a portal that shows the currently available bids on the RAN resource exchange server, and/or push notifications to actively notify telco operators of new bid requests that indicate opportunities to obtain additional RAN resources.

At 354, a bid response is received. The bid response can include receiving a message from a telco operator over a computer network. The bid response can include metadata pertaining to the bid response. The metadata can include a bid response number. The bid response number is a unique number associated with a given bid response. The metadata can include a bid request number indicative of the bid request to which this bid response is associated with. The metadata can include a requested capacity, in terms of bandwidth. The metadata can include time slots, indicative of when (e.g., a date, time and duration) the additional RAN resources are requested. The metadata can include a location, indicative of a localized geographical region where the additional RAN resources are needed. In embodiments, the location data is specified via a latitude-longitude pair, and a radius distance, to define a circular region. In some embodiments, the location data is specified with multiple latitude-longitude pairs, to define a specific boundary that defines the localized geographical region. In embodiments, the localized geographical region defines an area proximal (e.g., within one kilometer) of an enterprise location such as a sports stadium, hospital, university campus, or the like, that can experience a significant increase in mobile subscriber activity due to planned and/or unplanned events. The metadata for the bid response can also include payment information. The payment information can include the amount that the bidder is willing to pay, as well as other terms such as payment schedules and the like.

At 356, the bid response is evaluated. The bid response payment terms may be compared with minimum acceptable limits that are established by the LTIP and/or telco operator that is issuing the bid request. In some embodiments, more than one telco operator may provide a bid response to a bid request. In such embodiments, the bid responses may be compared, and the bid response that is most favorable (e.g., highest payment and/or quickest payment terms) may be awarded the RAN resources as specified in the bid request. In some embodiments, a bid score is computed at 358. In embodiments, the bid score B may be computed as:

B=K₁P(x)+K₂T(y), where

P(x) is a payment function, indicating a value based on the amount of pay x offered for the leasing of the RAN resources specified in the bid request. T(y) is a function corresponding to a value based on payment terms y (the payment schedule). K₁ and K₂ are constants. The bid score B is indicative of which bid response, amongst multiple bid responses, is the most lucrative and/or beneficial for the LTIP/telco operator issuing the bid request. Thus, embodiments can include generating a bid score based on the bid response.

At 360, a check is made to determine if the bid response is accepted. In embodiments, the bid response may be automatically accepted when the bid score B exceeds a predetermined value. If yes at 360, then the flow continues to 364 where the radio access network capacity/resources is provided (e.g., via lease, service agreement, etc.) to the telco operator associated with the accepted bid response. Provisioning occurs to enable the leasing of the RAN resources to the lessee telco operator. The provisioning can include setting network parameters such as firewalls, network routes, and invoking virtual machines, containerized applications, and the like, to associate the leased RAN resources with the lessee telco operator.

If no at 360, then the flow continues to 362 where the bid request is rejected, and or modified. If the bid request is modified, then the flow can continue back to 352, to repeat the process with the modified bid request. The modified bid request can include changing parameters such as spectrum allocation, QoS parameters, and the like. In some embodiments, a bid request can be split, in which case, the flow proceeds to 378, where the original bid request is split into multiple bid requests, that are then issued, with the flow returning back to 352. As an example, a bid request for 10 MHz of bandwidth can be split into two bid requests for 5 MHz of bandwidth. In embodiments, the splitting can be based on information received in bid responses. If the bid responses generate a bid score B that is lower than a predetermined threshold, the bid request can be split into smaller portions of RAN resources, so that the bid request offerings may better align with what the lessees are willing to pay.

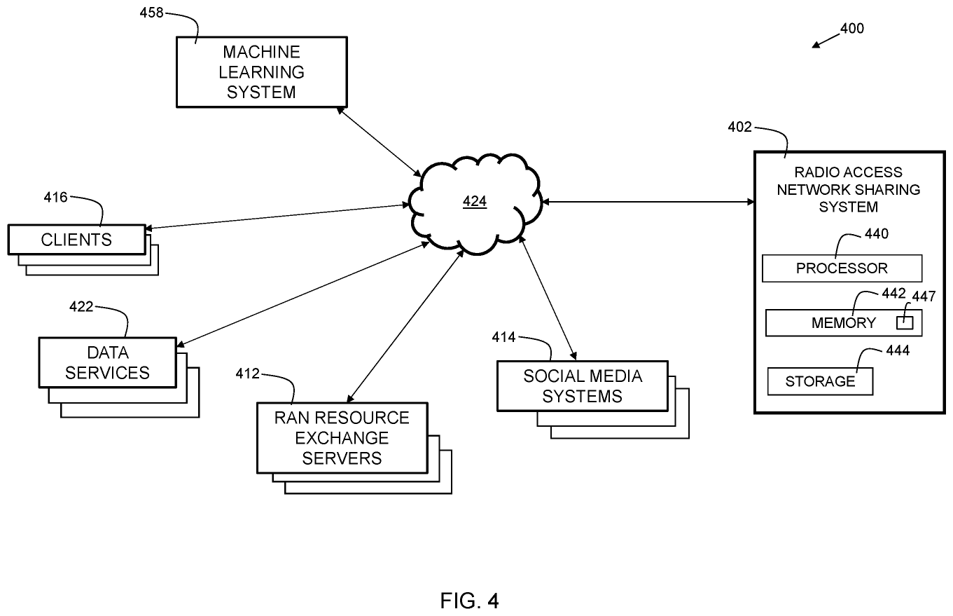

FIG. 4 shows elements of an exemplary ecosystem 400 in accordance with embodiments of the present invention. Radio Network Sharing System 402 comprises a processor 440, a memory 442 coupled to the processor 440, and storage 444. System 402 is an electronic computation device. The memory 442 contains program instructions 447, that when executed by the processor 440, perform processes, techniques, and implementations of disclosed embodiments. Memory 442 may include dynamic random-access memory (DRAM), static random-access memory (SRAM), magnetic storage, and/or a read only memory such as flash, EEPROM, optical storage, or other suitable memory and should not be construed as being a transitory signal per se. In some embodiments, storage 444 may include one or more magnetic storage devices such as hard disk drives (HDDs). Storage 444 may additionally include one or more solid state drives (SSDs). The Radio Network Sharing System 402 is configured to interact with other elements of ecosystem 400. Radio Network Sharing System 402 is connected to network 424, which can be the Internet, a wide area network, a local area network, and/or other suitable network.

Ecosystem 400 may include one or more client devices, indicated as 416. Client device 416 can include a laptop computer, desktop computer, tablet computer, smartphone, and/or other suitable computing device. Client device 416 may be used to configure Radio Network Sharing System 402, issue bid requests, issue bid responses, and/or configure/execute other features for disclosed embodiments.

Ecosystem 400 may include one or more data services 422. The data services 422 can include, but are not limited to, road traffic data services, weather data services, sports schedule data services, and/or other relevant data services. The data services can be used as criteria to determine average estimated bandwidth usage, which can in turn be used to determine appropriate pricing set forth in bid requests and/or bid responses.

Ecosystem 400 may include one or more RAN resource exchange servers 412. The RAN resource exchange servers may provide functionality for storing bid requests and bid responses, as well as exposing application programming interfaces (APIs) for placing, accepting, and/or modifying bid requests and/or bid responses.

Ecosystem 400 may include one or more social media systems 414. The social media systems 414 can be scraped by the Radio Access Network Sharing system 402 to determine impromptu events and occurrences that can impact mobile subscriber population in a given localized geographical region. The information gathered from social media systems 414, such as an event schedule, can be used as criteria to determine average estimated bandwidth usage, which can in turn be used to determine appropriate pricing set forth in bid requests and/or bid responses.

Ecosystem 400 may include machine learning system 458. The machine learning system 458 can include, but is not limited to, a convolutional neural network (CNN), Recurrent Neural Network (RNN), Long Short Term Memory Network (LSTM), Radial Basis Function Network (RBFN), Multilayer Perceptron (MLP), and/or other suitable neural network type. In embodiments, the machine learning system 458 is trained using supervised learning techniques. Once trained, the machine learning system 458 may be used to predict times of excess RAN resource availability based on input data from data services 422, social media systems 414, and/or other input data. Over time, the machine learning system 458 may be used to identify latent trends regarding excess RAN resources. Thus, in embodiments, machine learning system 458 can be used to identify trends in RAN resource availability, that can be used to improve utilization of radio access network (RAN) resources. In embodiments, the evaluated data can be fed back into the machine learning system 458 in order to further improve the quality of the output of the machine learning system 458 as part of a continuous training cycle.

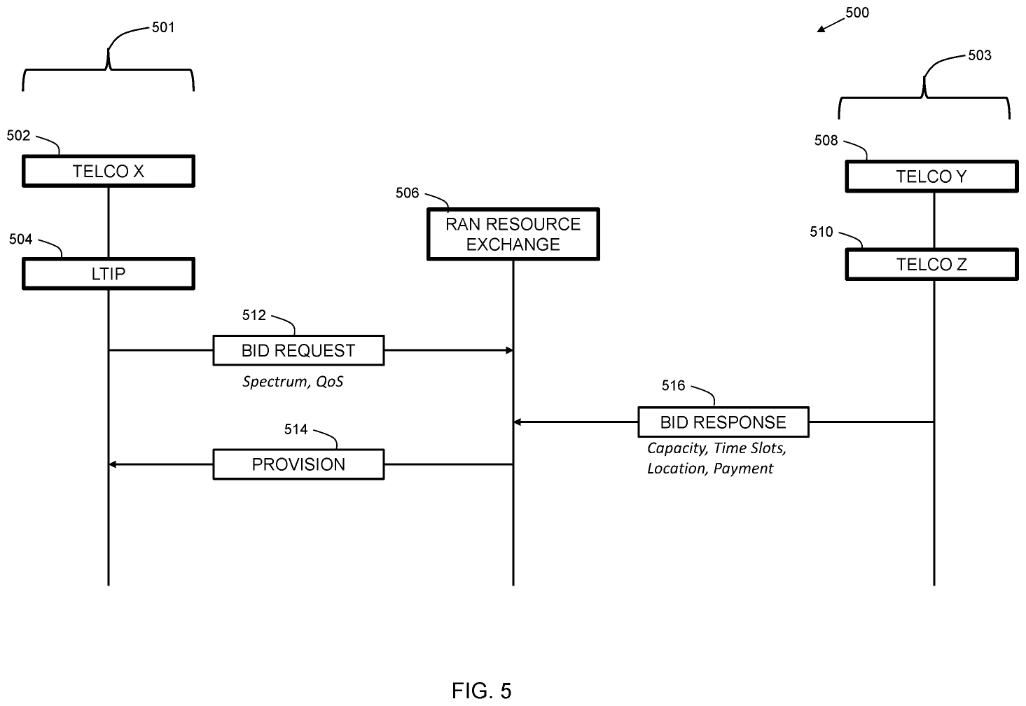

FIG. 5 is a sequence diagram 500 for disclosed embodiments. Sequence diagram 500 includes lessors 501. Lessors 501 can include an LTIP 504, and/or a telco operator, indicated as telco X 502. Sequence diagram 500 further includes lessees 503. In embodiments, the lessees include one or more telco operators, indicated as telco Y 508, and telco Z 510.

As an example, telco Y and telco Z may wish to temporarily lease additional radio access network resources from telco X. A possible scenario is that telco X owns the radio access network infrastructure in a particular localized geographic region, such as that of a convention center. When no convention is in progress, telco Y and telco Z have sufficient radio access network resources for the area proximal to the convention center. However, when there is a convention in progress, the number of mobile subscribers for telco Y and telco Z can dramatically increase for the duration of the convention. The lessors 501 can submit a bid request (bandwidth offer) 512 to a RAN resource exchange 506. The bid request 512 can contain various pieces of metadata. The metadata can include spectrum allocation information. The spectrum allocation information can include one or more radio frequencies included in the bid request. The metadata may further include a quality-of-service (QoS) dataset. The QoS dataset can include one or more parameters describing an expected QoS for the RAN resource allocation pertaining to the bid request. The QoS parameters can include, but are not limited to, download speed, upload speed, latency, jitter, and/or retransmission rates. The bid request, upon being received by the RAN resource exchange, can be available to telco operators that are interested in temporarily expanding capacity.

Continuing with the example, to help maintain an acceptable level of service during the convention, telco Y and/or telco Z can bid on available RAN resources. The RAN resource exchange 506 can expose available bid requests to the lessees 503. The lessees can submit a bid response (bandwidth offer response) 516 to the RAN resource exchange 506. Each bid response can include metadata. The metadata can include a bid response number. The bid response number is a unique number associated with a given bid response. The metadata can include a bid request number indicative of the bid request to which this bid response is associated with. The metadata can include a requested capacity, in terms of bandwidth. The metadata can include time slots, indicative of when (e.g., a date, time and duration) the additional RAN resources are requested. Thus, in embodiments, the bid request includes a spectrum allocation. In embodiments, the bid request includes a quality-of-service (QoS) dataset. In embodiments, the bid response includes a time and duration. In embodiments, the time is specified in UTC (Coordinated Universal Time) in seconds based on a given epoch, or other suitable format, and the duration ranges from one hour to 48 hours. In embodiments, the bid response includes a location. If the bid response is approved, then the RAN resource exchange 506 sends a provision message 514 to the lessor 501 to enable the allocation of RAN resources for the lessee 503.

In some embodiments, the RAN resource exchange 506 includes a radio access network sharing system such as depicted at 402 of FIG. 4. The radio access network sharing system can perform various functions in accordance with disclosed embodiments. In some embodiments, the radio access network sharing system can process bid requests and corresponding bid responses, and automatically accept and/or reject bid responses based on predefined criteria. The criteria can include a minimum price, a maximum bandwidth request, a maximum QoS level, and/or other criteria. In embodiments, the first bid response to meet all the criteria is automatically accepted, and a corresponding provision message 514 is generated. In some embodiments, the available resources in a bid request may be split, and awarded to multiple telcos that submit a bid response.

As can now be appreciated, disclosed embodiments provide localized telecommunications infrastructure providers with a dynamic exchange to allow network operators to broadcast borrow/lease requirements of needed/unutilized resources. The requirements can be on a time basis, service level, and/or localized geographic region. Mutual agreements between lessors and lessees are identified, providing an opportunity to improve network resource utilization and monetize the underutilized resources, and increase the average revenue per user (ARPU) for telco operators. Thus, disclosed embodiments provide techniques for creating a dynamic marketplace that enables telco operators to share proactively analyzed radio/platform/hardware resource shortages or surpluses, depending on location grids along with the desired/available QoS, and consumer count with the required time granularity of days and time slots at a time resolution of minutes. Embodiments can further provide techniques for integrating a RAN resource exchange with localized telecom infrastructure provider (LTIP) performing the infrastructure readiness (spectrum readiness, installation of radio units, towers, base stations etc.). Telco operators utilizing vNF/xNF functions expose the request to the RAN resource exchange with published APIs. Disclosed embodiments can further include inputting historical data into a machine learning system to analyze and provide optimal results for finding an optimal approach for provisioning the RAN resources. Thus, disclosed embodiments improve the technical field of communication network resource utilization.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for dynamic sharing of a radio access network, comprising:
determining a radio access network excess capacity factor;
in response to the radio access network excess capacity factor exceeding a predetermined threshold, issuing a radio access network bandwidth offer;
receiving a radio access network bandwidth offer response from a user, wherein the bandwidth offer response includes a localized geographical region;
evaluating the radio access network bandwidth offer response; and
providing a portion of the radio access network to the user based on the evaluating of the radio access network bandwidth offer response.

2. The method of claim 1, wherein the bandwidth offer includes metadata that includes a spectrum allocation.

3. The method of claim 1, wherein the bandwidth offer includes metadata that includes a quality-of-service (QoS) dataset.

4. The method of claim 1, wherein the bandwidth offer response includes a time and duration, wherein the duration is in a range from one hour to 48 hours.

5. The method of claim 1, wherein the bandwidth offer is based on an event schedule obtained from a social media system.

6. The method of claim 1, wherein the evaluating includes computing a capacity projection.

7. The method of claim 6, wherein the evaluating is based on crowdsourced location service data.

8. The method of claim 1, further comprising generating a bid score based on the bandwidth offer response, wherein the bid score is a function of payment terms.

9. An electronic computation device comprising:
a processor;
a memory coupled to the processor, the memory containing instructions, that when executed by the processor, cause the electronic computation device to:
determine a radio access network excess capacity factor;
in response to the radio access network excess capacity factor exceeding a predetermined threshold, issue a radio access network bandwidth offer;
receive a radio access network bandwidth offer response from a user, wherein the bandwidth offer response includes a localized geographical region;
evaluate the radio access network bandwidth offer response; and
provide a portion of the radio access network to the user based on the evaluating of the radio access network bandwidth offer response.

10. The electronic computation device of claim 9, wherein the memory further comprises instructions, that when executed by the processor, cause the electronic computation device to include a spectrum allocation in the bandwidth offer.

11. The electronic computation device of claim 9, wherein the memory further comprises instructions, that when executed by the processor, cause the electronic computation device to include a quality-of-service (QoS) dataset in the bandwidth offer.

12. The electronic computation device of claim 9, wherein the memory further comprises instructions, that when executed by the processor, cause the electronic computation device to receive a time and duration in the bandwidth offer, wherein the duration is in a range from one hour to 48 hours.

13. The electronic computation device of claim 9, wherein the memory further comprises instructions, that when executed by the processor, cause the electronic computation device to issue the bandwidth offer based on an event schedule obtained from a social media system.

14. The electronic computation device of claim 9, wherein the memory further comprises instructions, that when executed by the processor, cause the electronic computation device to compute a capacity projection.

15. The electronic computation device of claim 9, wherein the memory further comprises instructions, that when executed by the processor, cause the electronic computation device to generate a bid score based on the bandwidth offer response, wherein the bid score is a function of payment terms.

16. A computer program product for an electronic computation device comprising a computer readable storage medium having program instructions embodied therewith, the program instructions executable by a processor to cause the electronic computation device to:
determine a radio access network excess capacity factor;
in response to the radio access network excess capacity factor exceeding a predetermined threshold, issue a radio access network bandwidth offer;
receive a radio access network bandwidth offer response from a user;
evaluate the radio access network bandwidth offer response; and
provide a portion of the radio access network to the user based on the evaluating of the radio access network bandwidth offer response.

17. The computer program product of claim 16, wherein the computer readable storage medium further comprises instructions, that when executed by the processor, cause the electronic computation device to include a spectrum allocation in the bandwidth offer.

18. The computer program product of claim 16, wherein the computer readable storage medium further comprises instructions, that when executed by the processor, cause the electronic computation device to include a quality-of-service (QoS) dataset in the bandwidth offer.

19. The computer program product of claim 16, wherein the computer readable storage medium further comprises instructions, that when executed by the processor, cause the electronic computation device to compute a capacity projection.

20. The computer program product of claim 16, wherein the computer readable storage medium further comprises instructions, that when executed by the processor, cause the electronic computation device to generate a bid score based on the bandwidth offer response, wherein the bid score is a function of payment terms.
